(19) United States
(12) Patent Application Publication
(10) Pub. No.: US 2026/0187778 A1
(43) Pub. Date: Jul. 2, 2026

(54) IMAGE FUSION-BASED MONITORING SYSTEM FOR SINTERED MATERIAL IN LITHIUM-ION BATTERY MATERIAL SINTERING FURNACE

(71) Applicant: JIANGSU QIANJIN FURNACE INDUSTRYEQUIPMENT CO., LTD., Yixing City (CN)

(72) Inventors: Jun LIU, Yixing City (CN); Guojun WU, Yixing City (CN); Zhi YE, Yixing City (CN)

(21) Appl. No.: 19/430,165

(22) Filed: Dec. 22, 2025

(30) Foreign Application Priority Data
Dec. 26, 2024 (CN) 2024119310520

(51) Int. Cl. G06T 7/00; G06T 5/70; G06T 7/11; G06T 7/60

(52) U.S. Cl. CPC G06T 7/0004; G06T 5/70; G06T 7/11; G06T 7/60; G06T 2207/10016; G06T 2207/20221

(57) ABSTRACT

The present disclosure relates to the technical field of sintering furnaces, particularly to an image fusion-based monitoring system for sintered materials in a lithium-ion battery material sintering furnace, which includes: a capture layer, an analysis layer, and a determination layer, where graphite particle image data during a heating sintering stage and a cooling and discharging stage in the sintering furnace are acquired through the capture layer, the graphite particle image data are performed noise point removal in the capture layer, and then the graphite particle image data are performed a storage operation, the analysis layer synchronously receives the stored graphite particle image data from the capture layer. By acquiring graphite particle image data at the heating sintering stage and the cooling and discharging stage in the sintering process, the present disclosure analyzes the sintered graphite particle integrity in the sintering furnace.

### CROSS-REFERENCE TO RELATED APPLICATIONS

This application claims priority to Chinese Patent Application No. 202411931052.0, filed on Dec. 26, 2024, which is incorporated herein by reference in its entirety.

### TECHNICAL FIELD

The present disclosure relates to the technical field of sintering furnaces, and particularly to an image fusion-based monitoring system for sintered materials in a lithium-ion battery material sintering furnace.

### BACKGROUND

Graphite plays a significant role in lithium-ion batteries. It is commonly used as a negative electrode material in the lithium-ion batteries due to its excellent electrical conductivity and layered structure, which facilitate insertion and extraction of the lithium ions and enhance charge-discharge performance of the batteries. Lithium-ion battery management includes various aspects such as charge-discharge control and temperature management to ensure the safe, efficient, and long-lasting operation of the batteries.

An disclosure patent with application No. 202211056327.1 discloses a control system for a silicon carbide sintering furnace, characterized by including: a furnace body with a heat insulation chamber; a cooling pipe installed inside the furnace body, the cooling pipe having one end connected to an inlet pipe for introducing a coolant and another end connected to an outlet pipe for discharging the coolant, a fan installed inside the furnace body; and further including: a first detection unit configured to timely detect an inlet temperature J1 of the coolant in the inlet pipe; a second detection unit configured to timely detect an outlet temperature J2 of the coolant in the outlet pipe; a flow detection unit configured to acquire a flow rate W1 of the coolant at time t and a flow rate W2 at time t₀+1; a gas detection unit configured to timely detect a volume Q of gas rapidly introduced into the furnace body; and a calculation unit configured to calculate a heat absorption rate value P0 of the coolant in the cooling pipe that is carried away from the furnace body, based on the inlet temperature J1, the outlet temperature J2, and the real-time flow rate value of the coolant passing through the cooling pipe.

The present disclosure aims to address the problems of “cracks and other defects in the sintered product due to inaccurate temperature control during the sintering of silicon carbide in a sintering furnace, which affect its mechanical properties, and the inability to adjust the cooling process inside the furnace in real-time. During the forced cooling stage, a fan often operates continuously to circulate gas inside the furnace, resulting in high energy consumption and significantly increased costs”.

However, for the sintering of graphite materials in lithium-ion battery materials, the existing technology focuses on temperature control, effectively improving the quality of the sintered product of the graphite materials. However, during the sintering process of graphite materials in a sintering furnace, temperature variations in the heating sintering stage and the cooling and discharging stage can easily cause cracking in the sintered graphite particles. Cracked graphite particles are generally deemed as nonconforming products, and there is currently no application technology in the existing technology for this specific scenario of determination.

Therefore, an image fusion-based monitoring system for sintered materials in a lithium-ion battery material sintering furnace is provided.

### SUMMARY

To address the above-mentioned shortcomings of existing technologies, the present disclosure provides an image fusion-based monitoring system for sintered materials in a lithium-ion battery material sintering furnace, which solves the technical problems mentioned in the background art.

To achieve the above-mentioned objective, the present disclosure is implemented through the following technical solutions:
an image fusion-based monitoring system for sintered materials in a lithium-ion battery material sintering furnace, including: a capture layer, an analysis layer, and a determination layer; where
graphite particle image data during a heating sintering stage and a cooling and discharging stage in the sintering furnace are acquired through the capture layer, the graphite particle image data are performed noise point removal in the capture layer, and then the graphite particle image data are performed a storage operation, the analysis layer synchronously receives the stored graphite particle image data from the capture layer, graphite particle integrity is analyzed based on the graphite particle image data, and the determination layer synchronously receives sintering state graphite particle integrity analysis results from the analysis layer, and whether a current batch of sintered graphite particles in the current sintering furnace is qualified or not is determined based on the sintering state graphite particle integrity analysis results;
the analysis layer includes a retrieval module, an analysis module, and a forwarding module, where the retrieval module is configured to retrieve the stored graphite particle image data from the capture layer, the analysis module is configured to receive the retrieved graphite particle image data from the retrieval module and analyze the graphite particle integrity based on the graphite particle image data, and the forwarding module is configured to acquire graphite particle integrity analysis results from the analysis module and forward the analysis results to the determination layer;
a logic for graphite particle integrity analysis in the analysis module is expressed as follows:

$$\{ \begin{matrix}Q = {[ \frac{1}{u} {\sum }_{v = 1}^{u} \frac{{S}_{{crack}_{i}}}{2 \times {S}_{i}} \times \frac{{S}_{{crack}_{i}}^{\frac{2}{3}}}{{V}_{i}^{\frac{2}{3}}} ]}^{- 1} & ( 1 ) \\ {Q}_{all} = {\sum }_{y = 1}^{x} {Q}_{y} \times {ω}_{y} & ( 2 )\end{matrix} ;$$

where Q represents the graphite particle integrity depicted in a single graphite particle image data; u represents a total number of graphite particle images with complete contours in the graphite particle image data; S_{crack}_{ᵢ} represents an area of a cracked region in an i^{th} group of graphite particle images; Sᵢ represents an area of the i^{th} group of graphite particle images within an overall image; Vᵢ represents a volume of the graphite particle corresponding to the i^{th} group of graphite particle images; Qₐₗₗ represents all graphite particle integrity analyzed from all the graphite particle image data; x represents a total number of the graphite particle image data; Q_{y} represents the graphite particle integrity depicted in the i^{th} graphite particle image data; and ω_{y} represents a configuration weight;
the area of the cracked region S_{crack}_{ᵢ} in the i^{th} group of graphite particle images and the area Sᵢ of the i^{th} group of graphite particle images within the image are S_{crack}_{ᵢ} represented based on a pixel count limit within the region or image, the area of the cracked region in the i^{th} group of graphite particle images is determined within the graphite particle image based on a preset grayscale threshold indicating cracking, and the volume of the graphite particle corresponding to the graphite particle image is determined by a maximum diameter of the graphite particle in the graphite particle image.

Further, the capture layer includes a camera module, an optimization module, and a storage module, the camera module is configured to acquire graphite particle image data at the heating sintering stage and the cooling and discharging stage in the sintering furnace, the optimization module is configured to receive the acquired graphite particle image data from the camera module, clean up noise points in the graphite particle image data, and the storage module is configured to acquire the optimized graphite particle image data from the optimization module and store the graphite particle image data;
the camera module is integrated with an illumination device and an ultra-high-definition industrial camera, when the camera module is configured to acquire graphite particle image data, the illumination device and the ultra-high-definition industrial camera operate synchronously, the illumination device illuminates spread-out sintered graphite particles in the sintering furnace, while the ultra-high-definition industrial camera simultaneously acquires the graphite particle image data, the storage module is configured to operate to store the graphite particle image data while identifying a graphite particle image data acquisition stage and storing the graphite particle image data separately based on the graphite particle image data acquisition stage.

Further, the camera module incorporates an operational logic that enables continuous operation at the heating sintering stage and the cooling and discharging stage to acquire the graphite particle image data.
the operational logic set in the camera module is as follows:
acquiring preset time for the heating sintering stage and the cooling and discharging stage during the operation of the sintering furnace, and setting two initial operating cycles corresponding to these two stages, denoted as a and b, and adjusting a and b based on graphite particle sintering parameters;

$${a}^{′} = a \times {[ \frac{h}{\overline{d} \times s} \times γ \times {[ \overline{{\sum }_{i = 1}^{n} {ψ}_{i}} ]}^{- 1} ]}^{- 1} ;$$

where a′ is an adjusted operating cycle of the camera module at the heating sintering stage; a is an initial operating cycle of the camera module at the heating sintering stage; h is a spread-out thickness of the graphite particles in the sintering furnace; d̅ is an average diameter of the graphite particles in the sintering furnace; S is a spread-out area of the graphite particles; y is an impurity content of the graphite particles; n is a total number of the graphite particle samples; and ψᵢ is sphericity of an i^{th} graphite particle sample;
where

$$\overline{{\sum }_{i = 1}^{n} {ψ}_{i}}$$

represents an average of

$${\sum }_{i = 1}^{n} {ψ}_{i} ,$$

the graphite particles are spherical embryos obtained through isostatic pressing, the average diameter d̅ of the graphite particles in the sintering furnace and the impurity content γ of the graphite particles are both measured based on the graphite particle samples, the total number of the graphite particle samples n is customized by a system-side user, and the parameters used for calculating a′ are the graphite particle sintering parameters.

Further, the adjusted operating cycle of the camera module during the cooling and discharging stage is denoted as b′, and a logic for calculating b′ is the same as that for calculating a′, with a≥b;
a calculation formula for sphericity of the graphite particle samples is as follows:

$$ψ = \frac{1}{m} \times {\sum }_{j = 1}^{m} [ 1 - \vert {d ( max )}_{j} - {d ( max )}_{j + 1} \vert ] ;$$

where ψ represents the sphericity of the graphite particle samples; m represents a total number of surface sampling points on the graphite particle sample; d(max)ⱼ represents a maximum diameter of the graphite particle samples at a location of a j^{th} surface sampling point;
the surface sampling points on the graphite particle samples are customized by a system-side user, with at least one sampling point in each of the six orthogonal directions of upper, lower, left, right, front, and back, and the closer the sphericity y of the graphite particle samples is to 1, the closer the graphite particle samples are to a sphere.

Further, a logic for cleaning up the noise points in the graphite particle image data in the optimization module is expressed as follows:
traversing each pixel in the graphite particle image data, identifying a pixel value of each pixel, and setting a noise point determination pixel value;
selecting one pixel from the graphite particle image data as a covering pixel;
determining each pixel in the graphite particle image data using the noise point determination pixel value, capturing pixels that match the noise point determination pixel value, using the pixels that match the noise point determination pixel value as a center of a window, and identifying whether all pixels within the window match the noise point determination pixel value, if yes, the captured pixel is determined not to be a noise point, if no, the captured pixel is determined to be a noise point;
covering the pixels determined to be noise points with the covering pixel;
where the window is set to any one of 3*3, 4*4, 5*5, etc., the window setting follows a rule that the higher a noise point determination accuracy requirement, the larger the window setting, conversely, the smaller the window setting.

Further, a logic for cleaning up the noise points in the graphite particle image data in the optimization module is expressed as follows:
traversing each pixel in the graphite particle image data, identifying a pixel value of each pixel, and setting a noise point determination pixel value;
selecting one pixel from the graphite particle image data as a covering pixel;
determining each pixel in the graphite particle image data using the noise point determination pixel value, capturing pixels that match the noise point determination pixel value, using the pixels that match the noise point determination pixel value as a center of a window, and identifying whether all pixels within the window match the noise point determination pixel value, if yes, the captured pixel is determined not to be a noise point, if no, the captured pixel is determined to be a noise point;
covering the pixels determined to be noise points with the covering pixel;
where the window is set to any one of 3*3, 4*4, 5*5, etc., the window setting follows a rule that the higher a noise point determination accuracy requirement, the larger the window setting, conversely, the smaller the window setting.

Further, among a total number x of

$${\sum }_{y = 1}^{x} {ω}_{y} = 1$$

and the graphite particle image data, each graphite particle image data is sorted based on an acquisition sequence, then ω_{y}, ω_{y+1}, ω_{y+2}, ω_{y+3}, . . . ;
ω_{y}, ω_{y+1}, ω_{y+2}, ω_{y+3}, . . . are all positive numbers, and the configuration weight centered in ω_{y}, ω_{y+1}, ω_{y+2}, ω_{y+3}, . . . is denoted as ω_{y/2}, then ω_{y}, ω_{y+1}, ω_{y+2}, . . . ω_{y/2} is an arithmetic increasing sequence;
ω_{y/2}, . . . is an arithmetic decreasing sequence.

Further, the determination layer includes a determination module, a setting module, and an output module, the determination module is configured to receive Qₐₗₗ analyzed from the analysis layer, set a qualification determination threshold, and determine whether the current batch of sintered graphite particles is qualified based on a comparison of the qualification determination threshold with Qₐₗₗ, the setting module is configured to set a segmentation window and provide feedback to the analysis layer to control the setting module to operate again, and the output module is configured to output a determination result from the determination module regarding whether the current batch of sintered graphite particles is qualified, or a status of the analysis layer being controlled by the setting module to operate again, and the determination result generated by the operation of the determination module;
a logic for the determination module to determine whether the current batch of sintered graphite particles is qualified is expressed as follows:

$$\{ \begin{matrix}ϑ = f ( {Q}_{{all}_{1}} , {Q}_{{all}_{2}} ) ( 1 ) \\ {Q}_{{all}_{1}} \geq \frac{ε - 1}{ε} \times {Q}_{{all}_{2}} ( 2 )\end{matrix} ;$$

where ϑ represents a determination value; f(⋅) represents a determination function; Qₐₗₗ₁ [symbol] Qₐₗₗ₂ represents all graphite particle integrity analyzed from all graphite particle image data acquired at the heating sintering stage, and all graphite particle integrity analyzed from all graphite particle image data acquired during the cooling and discharging stage; and ε represents a constant;
where when any item of Qₐₗₗ₁ [symbol] Qₐₗₗ₂ does not meet the qualification determination threshold, f(⋅)=0; when Qₐₗₗ₁ [symbol] Qₐₗₗ₂ all meet the qualification determination threshold, f(⋅)=1, the determination value ϑ=1, and formula (2) holds, the current batch of sintered graphite particles is determined as qualified, the constant is a positive integer ε other than 1 and follows a rule that the higher the required precision for determining whether the current batch of sintered graphite particles is qualified, the larger the value of the constant ε, conversely, the smaller the value of the constant.

Further, during the operation of the setting module to set the window, a 5*5 segmentation grid is set, with a window size of 3*3, four windows at the top-left, top-right, bottom-left, and bottom-right corners of the 5*5 grid are selected to segment the graphite particle image data, and the segmented data are denoted as sub-graphite particle image data, and the graphite particle integrity is analyzed in the analysis layer using the sub-graphite particle image data;
each time the graphite particle integrity is analyzed in the analysis layer based on the graphite particle integrity, the sub-graphite particle image data used comes from a same segmentation window;
the graphite particle integrity analyzed by the analysis layer based on the sub-graphite particle image data is further subjected to qualification determination by the determination layer, when the determination result is qualified, the graphite particles in the region corresponding to the segmentation window in the graphite particle image data are determined to be qualified graphite particles.

Further, the retrieval module is interconnected with the storage module via wireless network interconnection, the storage module is interconnected with the optimization module and the camera module via wireless network interconnection, the retrieval module is interconnected with the analysis module and the forwarding module via wireless network interconnection, the forwarding module is interconnected with the determination module via wireless network interconnection, and the determination module is interconnected with the setting module and the output module via wireless network interconnection.

The technical solution provided by the present disclosure has the following advantageous effects compared with the known common technology:
the present disclosure provides an image fusion-based monitoring system for sintered materials in a lithium-ion battery material sintering furnace. During operation of the system, by acquiring the graphite particle image data at the heating sintering stage and the cooling and discharging stage of the graphite particle sintering in the sintering furnace, the sintered graphite particle integrity in the sintering furnace is analyzed, which effectively identifies cracking defects in the graphite particles caused by temperature changes during the sintering process, ultimately providing a qualification determination for the sintered graphite particles in the sintering furnace and ensuring the quality of the sintered graphite particles in the sintering furnace.

At the same time, when the system first determines that the sintered graphite particles in the sintering furnace are unqualified, it can further perform a more detailed qualification determination on the locally sintered graphite particles in the sintering furnace using a segmentation window approach, which reduces a scrap rate of sintered graphite particles and optimizes the production cost of graphite particle sintering.

### BRIEF DESCRIPTION OF THE DRAWINGS

To illustrate the technical solutions in the embodiments of the present disclosure or in existing technologies more clearly, a brief introduction to the accompanying drawings used in the descriptions of the embodiments or existing technologies is provided below. Apparently, the accompanying drawings described below are only some embodiments of the present disclosure, and for a person skilled in the art, other accompanying drawings can also be obtained based on these accompanying drawings without exerting creative labor.

FIG. 1 is a schematic structural diagram illustrating an image fusion-based monitoring system for sintered materials in a lithium-ion battery material sintering furnace;

FIG. 2 is an example schematic diagram illustrating noise points in graphite particle image data according to the present disclosure; and

FIG. 3 is a schematic diagram illustrating logic of obtaining sub-graphite particle image data by segmenting graphite particle image data using a segmentation window according to the present disclosure.

### DETAILED DESCRIPTION OF THE EMBODIMENTS

To make the objectives, technical solutions, and advantages of the embodiments of the present disclosure clearer, the technical solutions in the embodiments of the present disclosure will be described clearly and completely below with reference to the accompanying drawings in the embodiments of the present disclosure. Obviously, the described embodiments are part of the embodiments of the present disclosure rather than all of them. Based on the embodiments of the present disclosure, all other embodiments obtained by a person skilled in the art without making creative efforts fall within the protection scope of the present disclosure.

Hereinafter, the present disclosure will be further described with reference to the embodiments.

### Embodiment 1

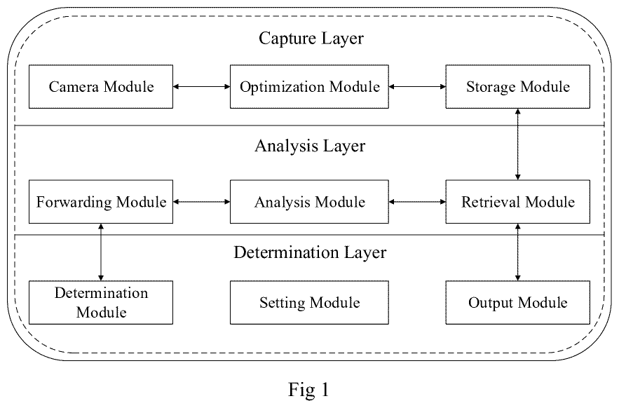

The present embodiment provides an image fusion-based monitoring system for sintered materials in a lithium-ion battery material sintering furnace, as shown in FIG. 1, including: a capture layer, an analysis layer, and a determination layer, where
graphite particle image data during a heating sintering stage and a cooling and discharging stage in the sintering furnace are acquired through the capture layer, the graphite particle image data are performed noise point removal in the capture layer, and then the graphite particle image data are performed a storage operation, the analysis layer synchronously receives the stored graphite particle image data from the capture layer, graphite particle integrity is analyzed based on the graphite particle image data, and the determination layer synchronously receives sintering state graphite particle integrity analysis results from the analysis layer, and whether a current batch of sintered graphite particles in the current sintering furnace is qualified or not is determined based on the sintering state graphite particle integrity analysis results;
the capture layer includes a camera module, an optimization module, and a storage module, the camera module is configured to acquire graphite particle image data at the heating sintering stage and the cooling and discharging stage in the sintering furnace, the optimization module is configured to receive the acquired graphite particle image data from the camera module, clean up noise points in the graphite particle image data, and the storage module is configured to acquire the optimized graphite particle image data from the optimization module and store the graphite particle image data;
the camera module is integrated with an illumination device and an ultra-high-definition industrial camera, when the camera module is configured to acquire graphite particle image data, the illumination device and the ultra-high-definition industrial camera operate synchronously, the illumination device illuminates spread-out sintered graphite particles in the sintering furnace, while the ultra-high-definition industrial camera simultaneously acquires the graphite particle image data, the storage module is configured to operate to store the graphite particle image data while identifying a graphite particle image data acquisition stage and storing the graphite particle image data separately based on the graphite particle image data acquisition stage;
the camera module incorporates an operational logic that enables continuous operation at the heating sintering stage and the cooling and discharging stage to acquire the graphite particle image data;
the operational logic set in the camera module is as follows:
acquiring preset time for the heating sintering stage and the cooling and discharging stage during the operation of the sintering furnace, and setting two initial operating cycles corresponding to these two stages, denoted as a and b, and adjusting a and b based on graphite particle sintering parameters;

$${a}^{′} = a \times {[ \frac{h}{\overline{d} \times s} \times γ \times {[ \overline{{\sum }_{i = 1}^{n} {ψ}_{i}} ]}^{- 1} ]}^{- 1} ;$$

where a′ is an adjusted operating cycle of the camera module at the heating sintering stage; a is an initial operating cycle of the camera module at the heating sintering stage; h is a spread-out thickness of the graphite particles in the sintering furnace; d̅ is an average diameter of the graphite particles in the sintering furnace; S is a spread-out area of the graphite particles; γ is an impurity content of the graphite particles; n is a total number of the graphite particle samples; and ψᵢ is sphericity of an i^{th} graphite particle sample;
where

$$\overline{{\sum }_{i = 1}^{n} {ψ}_{i}}$$

represents an average of

$${\sum }_{i = 1}^{n} {ψ}_{i} ,$$

the graphite particles are spherical embryos obtained through isostatic pressing, the average diameter d̅ of the graphite particles in the sintering furnace and the impurity content γ of the graphite particles are both measured based on the graphite particle samples, the total number of the graphite particle samples n is customized by a system-side user, and the parameters used for calculating a′ are the graphite particle sintering parameters;
the adjusted operating cycle of the camera module during the cooling and discharging stage is denoted as b′, and a logic for calculating b′ is the same as that for calculating a′, with a≥b;
a calculation formula for sphericity of the graphite particle samples is as follows:

$$ψ = \frac{1}{m} \times {\sum }_{j = 1}^{m} [ 1 - \vert {d ( max )}_{j} - {d ( max )}_{j + 1} \vert ] ;$$

where ψ represents the sphericity of the graphite particle samples; m represents a total number of surface sampling points on the graphite particle sample; d(max)ⱼ represents a maximum diameter of the graphite particle samples at a location of a j^{th} surface sampling point;
the surface sampling points on the graphite particle samples are customized by a system-side user, with at least one sampling point in each of the six orthogonal directions of upper, lower, left, right, front, and back, and the closer the sphericity y of the graphite particle samples is to 1, the closer the graphite particle samples are to a sphere;
the analysis layer includes a retrieval module, an analysis module, and a forwarding module, where the retrieval module is configured to retrieve the stored graphite particle image data from the capture layer, the analysis module is configured to receive the retrieved graphite particle image data from the retrieval module and analyze the graphite particle integrity based on the graphite particle image data, and the forwarding module is configured to acquire graphite particle integrity analysis results from the analysis module and forward the analysis results to the determination layer;
a logic for graphite particle integrity analysis in the analysis module is expressed as follows:

$$\{ \begin{matrix}Q = {[ \frac{1}{u} {\sum }_{v = 1}^{u} \frac{{S}_{{crack}_{i}}}{2 \times {S}_{i}} \times \frac{{S}_{{crack}_{i}}^{\frac{2}{3}}}{{V}_{i}^{\frac{1}{2}}} ]}^{- 1} ( 1 ) \\ {Q}_{all} = {\sum }_{y = 1}^{x} {Q}_{y} \times {ω}_{y} ( 2 )\end{matrix} ;$$

where Q represents the graphite particle integrity depicted in a single graphite particle image data; u represents a total number of graphite particle images with complete contours in the graphite particle image data; S_{crack}_{ᵢ}; represents an area of a cracked region in an i^{th} group of graphite particle images; Sᵢ represents an area of the i^{th} group of graphite particle images within an overall image; Vᵢ represents a volume of the graphite particle corresponding to the i^{th} group of graphite particle images; Qₐₗₗ represents all graphite particle integrity analyzed from all the graphite particle image data; x represents a total number of the graphite particle image data; Q_{y} represents the graphite particle integrity depicted in the i^{th} graphite particle image data; and ω_{y} represents a configuration weight;
the area of the cracked region S_{crack}_{ᵢ} in the i^{th} group of graphite particle images and the area Sᵢ of the i^{th} group of graphite particle images within the image are represented based on a pixel count limit within the region or image, the area S_{crack}_{ᵢ} of the cracked region in the i^{th} group of graphite particle images is determined within the graphite particle image based on a preset grayscale threshold indicating cracking, and the volume of the graphite particle corresponding to the graphite particle image is determined by a maximum diameter of the graphite particle in the graphite particle image;
the determination layer includes a determination module, a setting module, and an output module, the determination module is configured to receive Qₐₗₗ analyzed from the analysis layer, set a qualification determination threshold, and determine whether the current batch of sintered graphite particles is qualified based on a comparison of the qualification determination threshold with Qₐₗₗ, the setting module is configured to set a segmentation window and provide feedback to the analysis layer to control the setting module to operate again, and the output module is configured to output a determination result from the determination module regarding whether the current batch of sintered graphite particles is qualified, or a status of the analysis layer being controlled by the setting module to operate again, and the determination result generated by the operation of the determination module;
a logic for the determination module to determine whether the current batch of sintered graphite particles is qualified is expressed as follows:

$$\{ \begin{matrix}ϑ = f ( {Q}_{{all}_{1}} , {Q}_{{all}_{2}} ) ( 1 ) \\ {Q}_{{all}_{1}} \geq \frac{ε - 1}{ε} \times {Q}_{{all}_{2}} ( 2 )\end{matrix} ;$$

where ϑ represents a determination value; f(⋅) represents a determination function; Qₐₗₗ₁ [symbol] Qₐₗₗ₂ represents all graphite particle integrity analyzed from all graphite particle image data acquired at the heating sintering stage, and all graphite particle integrity analyzed from all graphite particle image data acquired during the cooling and discharging stage; and εrepresents a constant;
where when any item of Qₐₗₗ₁ [symbol] Qₐₗₗ₂ does not meet the qualification determination threshold, f(⋅)=0; when Qₐₗₗ₁ [symbol] Qₐₗₗ₂ all meet the qualification determination threshold, f(⋅)=1, the determination value 9=1, and formula (2) holds, the current batch of sintered graphite particles is determined as qualified, the constant is a positive integer ε other than 1 and follows a rule that the higher the required precision for determining whether the current batch of sintered graphite particles is qualified, the larger the value of the constant ε, conversely, the smaller the value of the constant;
the retrieval module is interconnected with the storage module via wireless network interconnection, the storage module is interconnected with the optimization module and the camera module via wireless network interconnection, the retrieval module is interconnected with the analysis module and the forwarding module via wireless network interconnection, the forwarding module is interconnected with the determination module via wireless network interconnection, and the determination module is interconnected with the setting module and the output module via wireless network interconnection.

In the present embodiment, the capture the camera module is configured to acquire graphite particle image data at the heating sintering stage and the cooling and discharging stage in the sintering furnace, the optimization module is configured to simultaneously receive the acquired graphite particle image data from the camera module, clean up noise points in the graphite particle image data, and the storage module is configured to timely acquire the optimized graphite particle image data from the optimization module and store the graphite particle image data; then, the retrieval module is configured to retrieve the stored graphite particle image data from the capture layer, the analysis module operates subsequently to receive the retrieved graphite particle image data from the retrieval module and analyzes the graphite particle integrity based on the graphite particle image data; the forwarding module is configured to synchronously acquire the graphite particle integrity analysis results from the analysis module and forwards the analysis results to the determination layer, the determination module is configured to receive Qₐₗₗ analyzed from the analysis layer, set a qualification determination threshold, and determine whether the current batch of sintered graphite particles is qualified based on a comparison of the qualification determination threshold with Qₐₗₗ, the setting module is configured to set a segmentation window and provide feedback to the analysis layer to control the setting module to operate again, and the output module is configured to output a determination result from the determination module regarding whether the current batch of sintered graphite particles is qualified, or a status of the analysis layer being controlled by the setting module to operate again, and the determination result generated by the operation of the determination module;

Based on an operation of the system in the above-mentioned embodiment and image analysis technology, the process of sintering graphite materials in the sintering furnace is monitored, effectively determining whether the sintered product of the graphite materials is qualified.

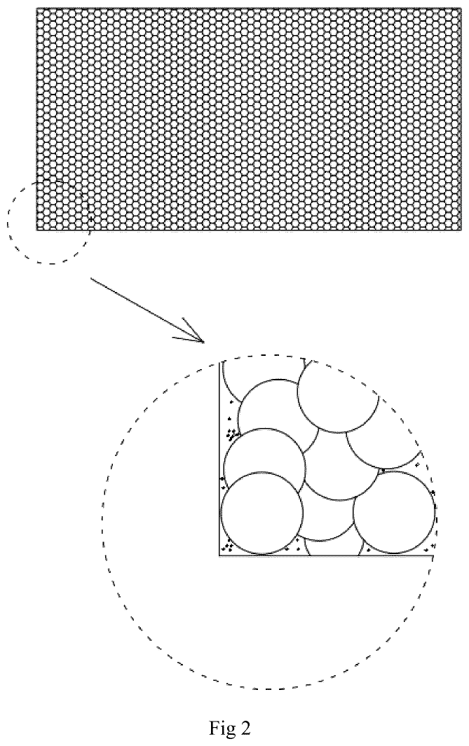

As shown in FIG. 2, an upper part of the figure represents an example of graphite particle image data. Based on the dashed circle and arrow indications, it shows the noise points contained in the graphite particle image data within the dashed circle area, i.e., the black dots in the enlarged figure. Most of these are debris or foreign matter generated from collisions between graphite particles during loading and sintering processes. Their presence in the graphite particle image data affects image accuracy, leading to deviations in the final determination results produced by the operation of the system. Therefore, a specific noise point removal logic is set in the system of the above-mentioned embodiment to ensure the accuracy of the output results from the operation of the system.

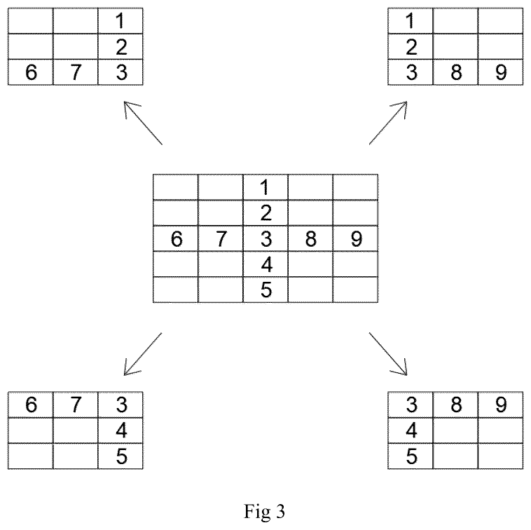

As shown in FIG. 3, at the center of the image, it represents graphite particle image data divided into a 5*5 grid. After performing window segmentation on the image data with a 3*3 window, four sets of sub-graphite particle image data are obtained. That is, when the system first determines that the graphite particles are not qualified in sintering, the system will use the four sets of sub-graphite particle image data as the targets for repeated processing to find as many qualified sintered graphite particle groups as possible in the graphite particle image data.

It should be noted that the numerical labels in the figure are only used to identify the source locations of the four sets of sub-graphite particle image data.

### Embodiment 2

In terms of specific implementation, based on Embodiment 1, the present embodiment provides further specific explanations for the image fusion-based monitoring system for sintered materials in a lithium-ion battery material sintering furnace in Embodiment 1, as shown in FIG. 1:
the logic for cleaning up noise points in the graphite particle image data in the optimization module is expressed as follows:
traversing each pixel in the graphite particle image data, identifying a pixel value of each pixel, and setting a noise point determination pixel value;
selecting one pixel from the graphite particle image data as a covering pixel;
determining each pixel in the graphite particle image data using the noise point determination pixel value, capturing pixels that match the noise point determination pixel value, using the pixels that match the noise point determination pixel value as a center of a window, and identifying whether all pixels within the window match the noise point determination pixel value, if yes, the captured pixel is determined not to be a noise point, if no, the captured pixel is determined to be a noise point;
covering the pixels determined to be noise points with the covering pixel;
where the window is set to any one of 3*3, 4*4, 5*5, etc., the window setting follows a rule that the higher a noise point determination accuracy requirement, the larger the window setting, conversely, the smaller the window setting.

Through the above settings, the logic for cleaning up noise points in the graphite particle image data are defined to ensure the quality of the graphite particle image data and improve the accuracy of output results from the operation of the system.

As shown in FIG. 1, the retrieval module operates continuously twice during an operation stage of the analysis layer, the analysis module operates synchronously with the retrieval module, during a first operation of the retrieval module, the retrieval module is configured to retrieve the graphite particle image data acquired at the heating sintering stage and stored in the storage module of the capture layer, during a second operation of the retrieval module, the retrieval module is configured to retrieve the graphite particle image data acquired during the cooling and discharging stage and stored in the storage module of the capture layer;
during an operation stage of the analysis module, after receiving the graphite particle image data, the graphite particle image data are converted into grayscale images and then a graphite particle integrity analysis operation is performed;
the forwarding module is configured to continuously receive the graphite particle integrity analyzed by the analysis module, the forwarding module is configured to receive two sets of graphite particle integrity analysis results and packages the accumulated graphite particle integrity analysis results and forwards the graphite particle integrity analysis results to the determination layer of the system.

Through the above settings, further operational logic support is provided for the operation of the system in Embodiment 1 to ensure more stable operation of the system in Embodiment 1.

As shown in FIG. 1,

$${\sum }_{y = 1}^{x} {ω}_{y} = 1 ,$$

among a total number of x and the graphite particle image data, each graphite particle image data is sorted based on an acquisition sequence, then ω_{y}, ω_{y+1}, ω_{y+2}, ω_{y+3}, . . . ,
ω_{y}, ω_{y+1}, ω_{y+2}, ω_{y+3}, . . . are all positive numbers, and the configuration weight centered in ω_{y}, ω_{y+1}, ω_{y+2}, ω_{y+3}, . . . is denoted as ω_{y/2}, then ω_{y}, ω_{y+1}, ω_{y+2}, . . . ω_{y/2} is an arithmetic increasing sequence;
ω_{y/2}, . . . is an arithmetic decreasing sequence.

Through the above settings, the logic for determining the value of the configuration weight is further defined.

As shown in FIG. 1, during the operation of the setting module to set the window, a 5*5 segmentation grid is set, with a window size of 3*3, four windows at the top-left, top-right, bottom-left, and bottom-right corners of the 5*5 grid are selected to segment the graphite particle image data, and the segmented data are denoted as sub-graphite particle image data, and the graphite particle integrity is analyzed in the analysis layer using the sub-graphite particle image data;
each time the graphite particle integrity is analyzed in the analysis layer based on the graphite particle integrity, the sub-graphite particle image data used comes from a same segmentation window;
the graphite particle integrity analyzed by the analysis layer based on the sub-graphite particle image data is further subjected to qualification determination by the determination layer, when the determination result is qualified, the graphite particles in the region corresponding to the segmentation window in the graphite particle image data are determined to be qualified graphite particles.

Through the above settings, the logic for segmenting the graphite particle image data through the segmentation window and jumping to the system operation layer again in Embodiment 1, as well as the basis for the applied data, are further explained.

In summary, during operation of the system, by acquiring the graphite particle image data at the heating sintering stage and the cooling and discharging stage of the graphite particle sintering in the sintering furnace, the sintered graphite particle integrity in the sintering furnace is analyzed, which effectively identifies cracking defects in the graphite particles caused by temperature changes during the sintering process, ultimately providing a qualification determination for the sintered graphite particles in the sintering furnace and ensuring the quality of the sintered graphite particles in the sintering furnace. Meanwhile, when the system first determines that the sintered graphite particles in the sintering furnace are unqualified, it can further perform a more detailed qualification determination on the locally sintered graphite particles in the sintering furnace using a segmentation window approach, which reduces a scrap rate of sintered graphite particles and optimizes the production cost of graphite particle sintering.

The above embodiments are merely intended to illustrate the technical solutions of the present disclosure rather than limit it. Although the present disclosure has been described in detail with reference to the above embodiments, a person skilled in the art should understand that he may still modify the technical solutions described in the above respective embodiments, or make equivalent substitutions for some of the technical features thereof; and such modifications or substitutions do not cause the essence of the corresponding technical solutions to depart from the spirit and scope of the technical solutions of the respective embodiments of the present disclosure.

What is claimed is:

1. An image fusion-based monitoring system for sintered materials in a lithium-ion battery material sintering furnace, comprising: a capture layer, an analysis layer, and a determination layer; wherein
graphite particle image data during a heating sintering stage and a cooling and discharging stage in the sintering furnace are acquired through the capture layer, the graphite particle image data are performed noise point removal in the capture layer, and then the graphite particle image data are performed a storage operation, the analysis layer synchronously receives the stored graphite particle image data from the capture layer, graphite particle integrity is analyzed based on the graphite particle image data, and the determination layer synchronously receives sintering state graphite particle integrity analysis results from the analysis layer, and whether a current batch of sintered graphite particles in the current sintering furnace is qualified or not is determined based on the sintering state graphite particle integrity analysis results;
the analysis layer comprises a retrieval module, an analysis module, and a forwarding module, wherein the retrieval module is configured to retrieve the stored graphite particle image data from the capture layer, the analysis module is configured to receive the retrieved graphite particle image data from the retrieval module and analyze the graphite particle integrity based on the graphite particle image data, and the forwarding module is configured to acquire graphite particle integrity analysis results from the analysis module and forward the analysis results to the determination layer;
a logic for graphite particle integrity analysis in the analysis module is expressed as follows:
$$\{ \begin{matrix}Q = {[ \frac{1}{u} {\sum }_{v = 1}^{u} \frac{{S}_{{crack}_{i}}}{2 \times {S}_{i}} \times \frac{{S}_{{crack}_{i}}^{\frac{2}{3}}}{{V}_{i}^{\frac{1}{2}}} ]}^{- 1} ( 1 ) \\ {Q}_{all} = {\sum }_{y = 1}^{x} {Q}_{y} \times {ω}_{y} ( 2 )\end{matrix} ;$$
wherein [symbol] represents the graphite particle integrity depicted in a single graphite particle image data; [symbol] represents a total number of graphite particle images with complete contours in the graphite particle image data; S_{crack}_{ᵢ} represents an area of a cracked region in an i^{th} group of graphite particle images; Sᵢ represents an area of the i^{th} group of graphite particle images within an overall image; Vᵢ represents a volume of the graphite particle corresponding to the i^{th} group of graphite particle images; [symbol] represents all graphite particle integrity analyzed from all the graphite particle image data; x represents a total number of the graphite particle image data; [symbol] represents the graphite particle integrity depicted in the i^{th} graphite particle image data; and ω_{y} represents a configuration weight;
the area of the cracked region S_{crack}_{ᵢ} in the i^{th} group of graphite particle images and the area Sᵢ of the i^{th} group of graphite particle images within the image are represented based on a pixel count limit within the region or image, the area S_{crack}_{ᵢ} of the cracked region in the i^{th} group of graphite particle images is determined within the graphite particle image based on a preset grayscale threshold indicating cracking, and the volume of the graphite particle corresponding to the graphite particle image is determined by a maximum diameter of the graphite particle in the graphite particle image.

2. The image fusion-based monitoring system for sintered materials in a lithium-ion battery material sintering furnace according to claim 1, wherein the capture layer comprises a camera module, an optimization module, and a storage module, the camera module is configured to acquire graphite particle image data at the heating sintering stage and the cooling and discharging stage in the sintering furnace, the optimization module is configured to receive the acquired graphite particle image data from the camera module, clean up noise points in the graphite particle image data, and the storage module is configured to acquire the optimized graphite particle image data from the optimization module and store the graphite particle image data;
the camera module is integrated with an illumination device and an ultra-high-definition industrial camera, when the camera module is configured to acquire graphite particle image data, the illumination device and the ultra-high-definition industrial camera operate synchronously, the illumination device illuminates spread-out sintered graphite particles in the sintering furnace, while the ultra-high-definition industrial camera simultaneously acquires the graphite particle image data, the storage module is configured to operate to store the graphite particle image data while identifying a graphite particle image data acquisition stage and storing the graphite particle image data separately based on the graphite particle image data acquisition stage.

3. The image fusion-based monitoring system for sintered materials in a lithium-ion battery material sintering furnace according to claim 2, wherein the camera module has an operational logic that enables continuous operation at the heating sintering stage and the cooling and discharging stage to acquire the graphite particle image data;
the operational logic set in the camera module is as follows:
acquiring preset time for the heating sintering stage and the cooling and discharging stage during the operation of the sintering furnace, and setting two initial operating cycles corresponding to these two stages, denoted as a and b, and adjusting a and b based on graphite particle sintering parameters;
$${a}^{′} = a \times {[ \frac{h}{\overline{d} \times s} \times γ \times {[ \overline{{\sum }_{i = 1}^{n} {ψ}_{i}} ]}^{- 1} ]}^{- 1} ;$$
wherein a′ is an adjusted operating cycle of the camera module at the heating sintering stage; a is an initial operating cycle of the camera module at the heating sintering stage; h is a spread-out thickness of the graphite particles in the sintering furnace; d̅ is an average diameter of the graphite particles in the sintering furnace; S is a spread-out area of the graphite particles; γ is an impurity content of the graphite particles; n is a total number of the graphite particle samples; and ψᵢ is sphericity of an i^{th} graphite particle sample;
wherein
$$\overline{{\sum }_{i = 1}^{n} {ψ}_{i}}$$
represents an average of
$${\sum }_{i = 1}^{n} {ψ}_{i} ,$$
the graphite particles are spherical embryos obtained through isostatic pressing, the average diameter d̅ of the graphite particles in the sintering furnace and the impurity content γ of the graphite particles are both measured based on the graphite particle samples, the total number of the graphite particle samples n is customized by a system-side user, and the parameters used for calculating a′ are the graphite particle sintering parameters.

4. The image fusion-based monitoring system for sintered materials in a lithium-ion battery material sintering furnace according to claim 3, wherein the adjusted operating cycle of the camera module during the cooling and discharging stage is denoted as b′, and a logic for calculating b′ is the same as that for calculating a′, with a≥ b;
a calculation formula for sphericity of the graphite particle samples is as follows:
$$ψ = \frac{1}{m} \times {\sum }_{j = 1}^{m} [ 1 - \vert {d ( max )}_{j} - {d ( max )}_{j + 1} \vert ] ;$$
wherein ψ represents the sphericity of the graphite particle samples; m represents a total number of surface sampling points on the graphite particle sample; d(max)ⱼ represents a maximum diameter of the graphite particle samples at a location of a j^{th} surface sampling point;
the surface sampling points on the graphite particle samples are customized by a system-side user, with at least one sampling point in each of the six orthogonal directions of upper, lower, left, right, front, and back, and the closer the sphericity ψ of the graphite particle samples is to 1, the closer the graphite particle samples are to a sphere.

5. The image fusion-based monitoring system for sintered materials in a lithium-ion battery material sintering furnace according to claim 2, wherein a logic for cleaning up the noise points in the graphite particle image data in the optimization module is expressed as follows:
traversing each pixel in the graphite particle image data, identifying a pixel value of each pixel, and setting a noise point determination pixel value;
selecting one pixel from the graphite particle image data as a covering pixel;
determining each pixel in the graphite particle image data using the noise point determination pixel value, capturing pixels that match the noise point determination pixel value, using the pixels that match the noise point determination pixel value as a center of a window, and identifying whether all pixels within the window match the noise point determination pixel value, if yes, the captured pixel is determined not to be a noise point, if no, the captured pixel is determined to be a noise point;
covering the pixels determined to be noise points with the covering pixel;
wherein the window is set to any one of 3*3, 4*4, 5*5, etc., the window setting follows a rule that the higher a noise point determination accuracy requirement, the larger the window setting, conversely, the smaller the window setting.

6. The image fusion-based monitoring system for sintered materials in a lithium-ion battery material sintering furnace according to claim 1, wherein the retrieval module operates continuously twice during an operation stage of the analysis layer, the analysis module operates synchronously with the retrieval module, during a first operation of the retrieval module, the retrieval module is configured to retrieve the graphite particle image data acquired at the heating sintering stage and stored in the storage module of the capture layer, during a second operation of the retrieval module, the retrieval module is configured to retrieve the graphite particle image data acquired during the cooling and discharging stage and stored in the storage module of the capture layer;
during an operation stage of the analysis module, after receiving the graphite particle image data, the graphite particle image data are converted into grayscale images and then a graphite particle integrity analysis operation is performed;
the forwarding module is configured to continuously receive the graphite particle integrity analyzed by the analysis module, the forwarding module is configured to receive two sets of graphite particle integrity analysis results and packages the accumulated graphite particle integrity analysis results and forwards the graphite particle integrity analysis results to the determination layer of the system.

7. The image fusion-based monitoring system for sintered materials in a lithium-ion battery material sintering furnace according to claim 1, wherein among a total number x of
$${\sum }_{y = 1}^{x} {ω}_{y} = 1 ,$$
and the graphite particle image data, each graphite particle image data is sorted based on an acquisition sequence, then ω_{y}, ω_{y+1}, ω_{y}+y+2, ω_{y+3}, . . . ; ω_{y}, ω_{y+1}, ω_{y+2}, ω_{y+3}, . . . .
are all positive numbers, and the configuration weight centered in ω_{y}, ω_{y+1}, ω_{y+2}, ω_{y+3}, . . . is denoted as ω_{y/2}, then ω_{y}, ω_{y+1}, ω_{y+2}, . . . ω_{y/2} is an arithmetic increasing sequence;
ω_{y/2}, . . . is an arithmetic decreasing sequence.

8. The image fusion-based monitoring system for sintered materials in a lithium-ion battery material sintering furnace according to claim 1, wherein the determination layer comprises a determination module, a setting module, and an output module, the determination module is configured to receive [symbol] analyzed from the analysis layer, set a qualification determination threshold, and determine whether the current batch of sintered graphite particles is qualified based on a comparison of the qualification determination threshold with [symbol] the setting module is configured to set a segmentation window and provide feedback to the analysis layer to control the setting module to operate again, and the output module is configured to output a determination result from the determination module regarding whether the current batch of sintered graphite particles is qualified, or a status of the analysis layer being controlled by the setting module to operate again, and the determination result generated by the operation of the determination module;
a logic for the determination module to determine whether the current batch of sintered graphite particles is qualified is expressed as follows:
$$\{ \begin{matrix}Q = {[ \frac{1}{u} {\sum }_{v = 1}^{u} \frac{{S}_{{crack}_{i}}}{2 \times {S}_{i}} \times \frac{{S}_{{crack}_{i}}^{\frac{2}{3}}}{{V}_{i}^{\frac{1}{2}}} ]}^{- 1} ( 1 ) \\ {Q}_{all} = {\sum }_{y = 1}^{x} {Q}_{y} \times {ω}_{y} ( 2 )\end{matrix} ;$$
wherein ϑ represents a determination value; f(⋅) represents a determination function; [symbol] represents all graphite particle integrity analyzed from all graphite particle image data acquired at the heating sintering stage, and all graphite particle integrity analyzed from all graphite particle image data acquired during the cooling and discharging stage; and ε represents a constant;
wherein when any item of [symbol] does not meet the qualification determination threshold, f(⋅)=0; when [symbol] all meet the qualification determination threshold, f(⋅)=1, the determination value ϑ=1, and formula (2) holds, the current batch of sintered graphite particles is determined as qualified, the constant is a positive integer ε other than 1 and follows a rule that the higher the required precision for determining whether the current batch of sintered graphite particles is qualified, the larger the value of the constant ε, conversely, the smaller the value of the constant.

9. The image fusion-based monitoring system for sintered materials in a lithium-ion battery material sintering furnace according to claim 8, wherein during the operation of the setting module to set the window, a 5*5 segmentation grid is set, with a window size of 3*3, four windows at the top-left, top-right, bottom-left, and bottom-right corners of the 5*5 grid are selected to segment the graphite particle image data, and the segmented data are denoted as sub-graphite particle image data, and the graphite particle integrity is analyzed in the analysis layer using the sub-graphite particle image data;
each time the graphite particle integrity is analyzed in the analysis layer based on the graphite particle integrity, the sub-graphite particle image data used comes from a same segmentation window;
the graphite particle integrity analyzed by the analysis layer based on the sub-graphite particle image data is further subjected to qualification determination by the determination layer, when the determination result is qualified, the graphite particles in the region corresponding to the segmentation window in the graphite particle image data are determined to be qualified graphite particles.

10. The image fusion-based monitoring system for sintered materials in a lithium-ion battery material sintering furnace according to claim 1, wherein the retrieval module is interconnected with the storage module via wireless network interconnection, the storage module is interconnected with the optimization module and the camera module via wireless network interconnection, the retrieval module is interconnected with the analysis module and the forwarding module via wireless network interconnection, the forwarding module is interconnected with the determination module via wireless network interconnection, and the determination module is interconnected with the setting module and the output module via wireless network interconnection.
